(19) United States
(12) Patent Application Publication
(10) Pub. No.: US 2005/0280352 A1
(43) Pub. Date: Dec. 22, 2005

(54) Vertical electrode structure of white light emitting diode

(76) Inventor: Mu-Jen Lai, Chungli City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/982,810

(22) Filed: Nov. 8, 2004

(30) Foreign Application Priority Data
Jun. 18, 2004 (TW) 093209669

(51) Int. Cl. H05B 33/00

(52) U.S. Cl. 313/498; 313/512

(57) ABSTRACT

A white light emitting diode discloses a transparently conductive an adhesion layer combining the light emitting diode of GaN and ZnTe or ZnSe as the substrate of light transfer layer. While the light emitting diode of GaN emits a blue wavelength, the blue part is absorbed by the light transfer layer either in ZnTe or in ZnSe thereto emits another yellow wavelength. After the yellow light and the blue light mix together, the white light is produced.

### BACKGROUND OF THE INVENTION

1. Field of the Invention

The present Invention relates to the vertical electrode structure of white light emitting diode, In particular, the structure of the present invention is an innovative advancement over previous designs due to its vertical structure. Further, it uses a vertical type GaN LED and a light wavelength transfer substrate as a combination. It uses the light wavelength transfer substrate to absorb a part of blue light thereto emits the yellow light. Finally, the yellow light and the blue light mix together for producing the white light.

2. Description of the Related Art

FIG. 1 is a conventional use of a lateral electrode structure in the GaN white LED by a cross sectional description. White light emitting diode 1 includes: The first cladding layer, as an example, N-type GaN layer 11 over the base, such as the upper of sapphire 10 The middle between the base and the first cladding layer normally contains a buffer layer; no figure shows in the present invention. The active layer, as an example, InGaN 12 over the first cladding layer. More, the second cladding layer, as an example, P-type GaN layer 13 over the active layer. As shown in the Figure, the first cladding layer 15 and the second cladding layer 14 are different electrode layers with two different polarities such as an N-type electrode 15 and a P-type electrode 14. In conventional white LED technique, such shown in U.S. Pat. No. 5,998,925, it is most common white LED structure. The packaging resin contains a phosphorus during packaging in the above mentioned stacking structure, such as YAG phosphor 16. Please referring to FIG. 1A, the light is emitted from the active layer of the above mentioned stacking layer, such as blue light. Some part of the light is absorbed by YAG phosphor 16 for transforming to different wavelengths of the light, such as yellow light. By combining the two lights, it forms a white light.

However, the above mentioned lateral type of electrode WHITE LED uses an insulating material, sapphire, in a substrate, its thermal conductivity coefficient is low and the heat dissipation is poor. As a result, while the higher driving current is applied for long-term operation, the YAG phosphor 16 is easily defective caused by the heat. Further, the transfer efficiency decreases, and then chrominance is shifted. Besides, due to sapphire is used in the substrate 10 as an insulating material, the lateral electrode is required to manufacture thereto increases the extra required chip area. In other words, it causes chip production ability per unit decreased. More, it makes the manufacture in package and wire bond become more complicated, therefore, it increases the manufacturing cost.

In order to improve the above mentioned lateral type of electrode LED by using an insulating material in the bottom of substrate. Further, it uses a vertical type of electrode as a design in LED which also presents the bottom of the substrate with the light wavelength transfer as shown in FIG. 2. As shown in FIG. 2, the bottom of substrate is N-type ZnSe material 22. A N-type ZnSe buffer layer 23, a N-type ZnMgSSe cladding layer 24, a ZnCdSe/ZnSeMQW active layer 25, a P-type ZnMgSSe cladding layer 26 and a P-type ZnTe contact layer 27 are positioned on the substrate in order. The N-type ZnSe buffer layer 23 mainly uses for decreasing lattice mismatch in the middle of substrate 22 and N-type ZnMgSSe cladding layer 24. The both sides of ZnCdSe/ZnSe MQW 25, N-type ZnMgSSe cladding layer 24 and P-type ZnMgSSe cladding layer 26, have wider band gap compared to the active layer 25 for increasing carrier confinement effect.

Furthermore, the up and down sides of the above mentioned stacking structure, there are an N-type electrode 21 and a P-type electrode 28. When the P-type electrode 21 and the N-type electrode 28 provide adequate voltage, ZnCdSe/ZnSe MQW active layer 25 between the P—N contact layer emits a blue light. Some part of blue light is absorbed by the N-type ZnSe substrate, and then forms a yellow light. By mixing the blue light and the yellow light, the white light is formed.

In comparison with first mentioned lateral type electrode manufacture and the later mentioned vertical type LED manufacture, the later one not only has simpler process, but also can avoid above thermal conductivity problem and the required complex in package process. However, the lifetime of component in the later one while in the real application even can achieve 10000 hours as described in the journal JPN. J. Appl. Phys. Vol. 43(2004) pp. 1287 by T. Nakamura et al, the quality of the epitaxial layer in ZnSe series is still not ideal. Therefore, the light emitting efficiency is not as good as in GaN series. Besides, as shown in Journal, JPN. J. Appl. Phys. Vol. 41 (2002), pp. L246, M. Tamsda et al and JPN. J. Appl. Phys. Vol. 40(2001), pp. L918, B. Damilano et al, they mentioned a mixture type LED. It presents InGaN Quantum Well Intermixing QWI light emitting layer. The light emitting layer can emit a shorter blue wavelength, and mix with the longer green wavelength emitted from another light emitting layer. Therefore, it can emit the specialized chrominance of mixture light or white light. However, changes the In composition or the thickness of InGaN layer to achieve longer light emitting wavelength. Therefore, its light emitting efficiency is relatively decreased. Up to now the light emitting efficiency of such kind of WHITE LED is only ½ to ⅓ of YAG series products, so there still have some drawbacks.

In order to overcome the above mentioned problems, the present invention presents an innovative vertical structure of WHITE LEDs. It not only can overcome the chrominance shifting problem as happening in the conventional lateral type of electrode WHITE LED but also can improve the problem of low light emitting efficiency as existing in the conventional vertical type of electrode WHITE LED. The authors of the present invention long-term work hard to propose a new invention in WHITE LED field. According to authors' many years experience in research, design with his expertise knowledge, the present invention is proposed and applied for a patent for overcoming the mentioned problems.

### BRIEF DESCRIPTION OF THE DRAWINGS

FIG. 1 presents a convent ion ally lateral electrode structure of GaN series LEDs;

FIG. 1A presents a conventionally lateral electrode structure of WHITE LEDs;

FIG. 2 presents a conventionally vertical electrode design of GaN series LEDs;

FIGS. 3A to 3E are some preferred embodiments in the present invention showing the manufacture flow chart for the vertical electrode WHITE LEDs;

FIGS. 4A to 4D are some of preferred embodiments in the present invention showing the manufacture flow chart for vertical electrode WHITE LEDs;

FIG. 5A is another preferred embodiment in the present invention showing WHITE LEDs structure.

FIG. 5B is another preferred embodiment in the present invention showing WHITE LEDs structure.

FIG. 5C is another preferred embodiment in the present invention showing light wavelength transfer substrate with 2D photonic crystal structure;

FIG. 5D is another preferred embodiment in the present invention showing WHITE LEDs structure;

FIG. 6A is one of the preferred embodiments in the present invention showing WHITE LEDs structure;

FIG. 6B is one of preferred embodiment of the present invention showing WHITE LEDs structure; and

FIG. 6C is another preferred embodiment in the present invention showing WHITE LEDs structure.

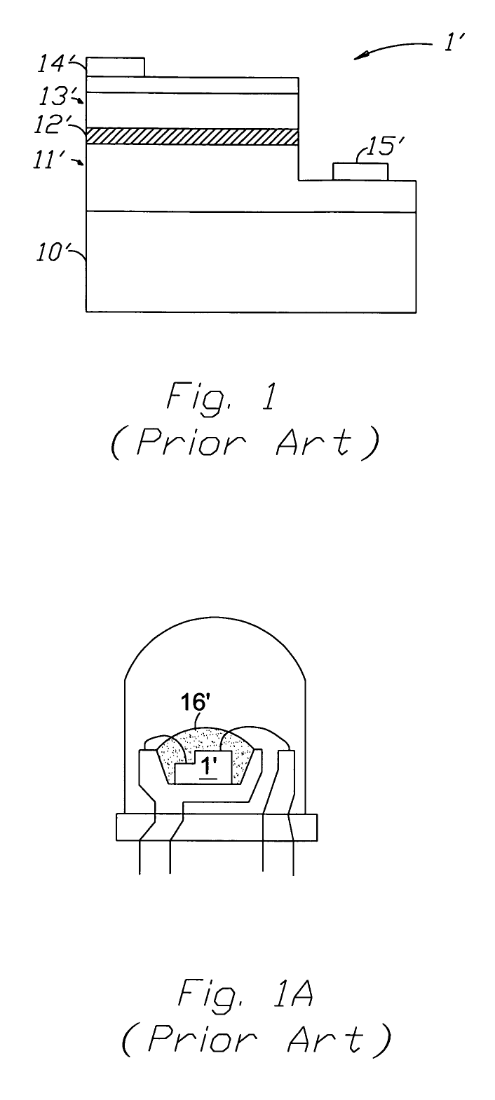

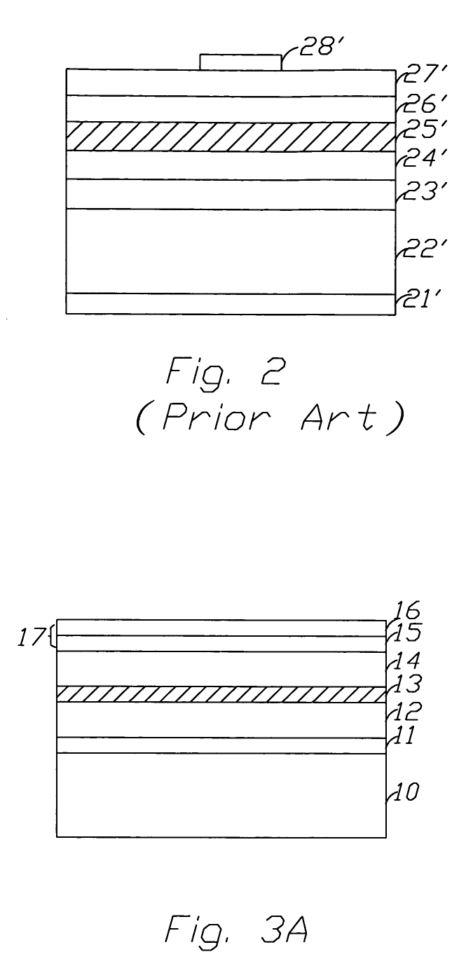

### SUMMARY OF THE INVENTION

In response to the foregoing challenges and to achieve the objects set forth above and other objects that will become apparent in the following description, an innovatively vertical electrode structure of white light emitting diode is provided. The present invention uses the combination of GaN LED and a light wavelength transfer substrate. The light wavelength transfer substrate absorbs the blue light of GaN series LED and emits the yellow light. The yellow light mixes with the blue light of GaN series LED, and produces a white light. By using the GaN series LED, it makes WHITE LED have better light emitting efficiency. Also, it can increases thermal conductive coefficient of the WHITE LED. As a result, it increases component's operational lifetime, and is more adequately for high driving voltage application. Further, it can increase electrostatic discharge (ESD) stand ability.

One of the objects in the present invention is to provide a vertical electrode structure of WHITE LEDs. It uses the GaN series LED and the light wavelength transfer substrate to form a white LED. Besides, it is a vertical electrode structure to decrease the unit area of chip process, and is further beneficial to wire bond and package process of the later manufacture.

In order to achieve the above mentioned purpose and function, the present invention is to provide a vertical electrode structure of WHITE LEDs. More, it first uses sapphire as a substrate. Then, compounded semiconductors of the epitaxial growth GaN series are stacked as LED structure. The thermal bonding technique using in a metal reflective layer and a conductive substrate combines the above mentioned GaN series LED structure. Then, it uses a laser lift-off technique to remove sapphire substrate. This method can manufacture the vertical electrode type of GaN series LED structure. Next, it uses a transparently conductive adhesion layer to combine the GaN series LED and, ZnTe or ZnSe light wavelength transfer substrate for forming WHITE LED of the present invention. While GaN series LED emits a blue wavelength, a part of the blue light is absorbed by ZnTe or ZnSe and forms the yellow light. By mixing the yellow light and the blue light, it can form the white light.

### DETAILED DESCRIPTION OF THE PREFERRED EMBODIMENTS

The present invention is to overcome the conventional WHITE LED technique, such as YAG Phosphor used in lateral electrode WHITE LED. Since insulating sapphire uses as substrate, its thermal conductivity coefficient is low, and the heat dissipation is poor. As a result, while the higher driving current is applied for long-term operation, the YAG phosphor 16 is easily defective caused by the heat. Further, the transfer efficiency decreases, and then chrominance is shifted. The lateral electrode is required to manufacture thereto increases the extra required chip area. In other words, it causes chip production ability per unit decreased. More, it makes the manufacture in package and wire bonding become more complicated, therefore, it increases the manufacturing cost. Besides, there are some drawbacks in the conventional WHITE LEDs even in vertical electrode technique. Since the quality of the epitaxial layer in ZnSe series is still not ideal, the light emitting efficiency is not as good as in GaN series. As a res u It, the present invention is to provide a vertical electrode structure of WHITE LEDs to increase light emitting efficiency of GaN series LED. Further, the vertical electrode structure can avoid the drawback of increased chip area in the lateral electrode. Also, the package and wire bonding problems can be overcome to produce white light.

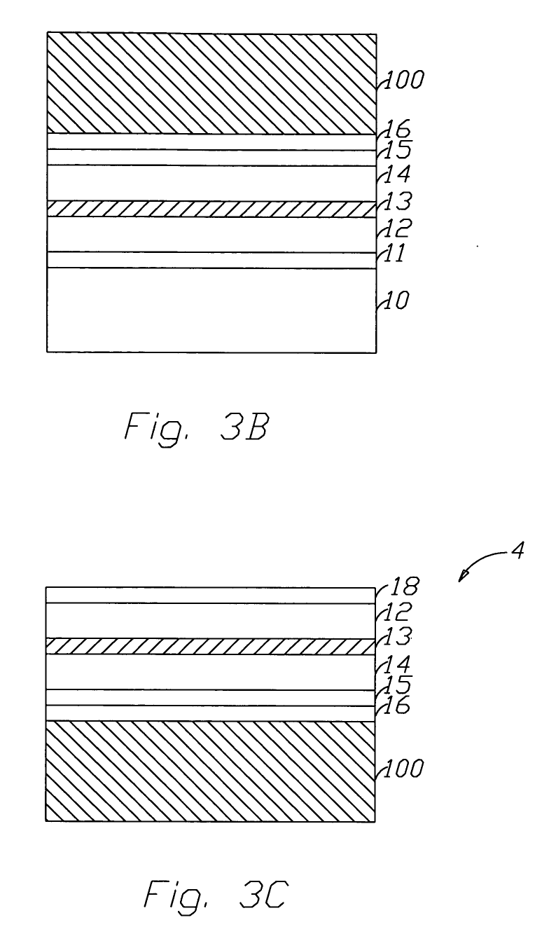

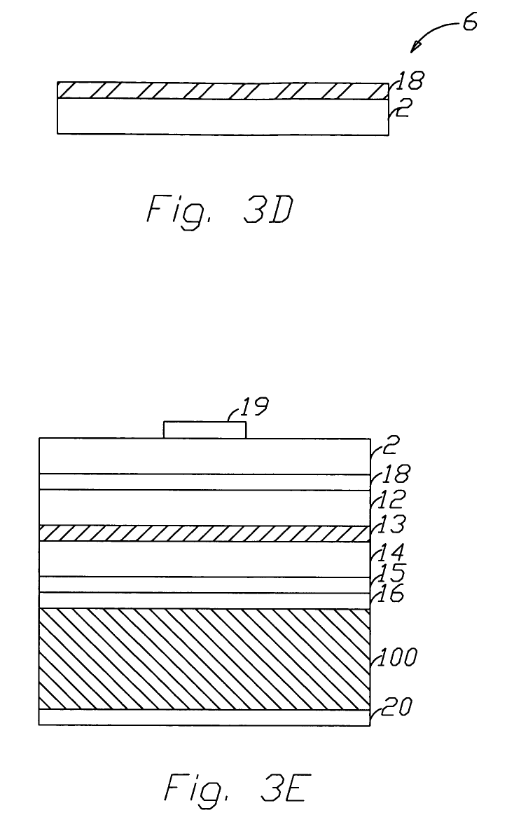

Please referring to FIG. 3A, it is one of the preferred embodiments in the present invention showing WHITE LEDs structure. As shown in the figure, the vertical electrode WHITE LED 1 in the first preferred embodiment firstly epitaxially grows a low temperature GaN buffer layer 11, a N-type AlInGaN ohmic contact layer 12, a AlInGaN light emitting layer 13, and a P-type AlInGaN ohmic contact layer 14 on a sapphire substrate 10 in order. Next, it either uses evaporate or sputter coating technique to make the transparently conductive ohmic contact layer 15 and a metal reflective layer 16 cover on P-type AlInGaN ohmic contact layer 14. The transparently conductive ohmic contact layer 15 and the metal reflective layer 16 are as the metal adhesion layer 17. Next, it uses conductive substrate 100 directly, or by evaporation or sputtering to coat another conductive layer and by heat to bond with the metal reflective layer 16. As shown in FIG. 3B, it uses laser lift-off and lapping technique to remove sapphire substrate 10 and shows N-type AlInGaN ohmic contact layer 12. Next, by evaporation or sputtering technique forms N-type transparently conductive adhesion layer 18 over on the N-type AlInGaN ohmic contact layer 12 as to a vertical electrode type of GaN LED structure 4 and on a N-type ZnSe or a N-type ZnTe light wavelength transfer substrate 2 as shown in FIG. 3C and FIG. 3D. Next, it uses a wafer bonding method to combine the structure 4 and the structure 6 as shown in FIG. 3E. Then, it manufactures the first electrode 20 and the second electrode 19. The N-type transparently conductive adhesion layer 18 can have good ohmic contact with the N-type AlInGaN ohmic contact layer 12, and N-type ZnSe or N-type ZnTe light wavelength transfer substrate as well as with better conductivity and transparency. When the first electrode 20 and the second electrode 19 provide adequate voltage, AlInGaN light emitting layer 13 in between the P—N contact layers emits the blue light. Some part of blue light is absorbed by the N-type ZnSe or N-type ZnTe light wavelength transfer substrate 2 to form a yellow light. By mixing the blue light and yellow light, it forms a white light.

The most common used structure in the preferred embodiments is the vertical electrode structure formed by GaN LED structure 4, conductive substrate 100, and the metal reflective layer 16. By using the N-type transparently conductive adhesion layer 18, it makes a light wavelength transfer substrate 2 adhere to the GaN LED structure 4. The metal reflective layer 16 has no choice to reflect for angle of incidence 16. Therefore, the bandwidth in angle of reflection can be increased. Further, it can efficiently reflect the light of the light emitting layer 13 to increase light emitting efficiency. Also, the structure can increase thermal conductivity and ESD stand ability. As a result, it increases component's operational lifetime, and is more adequately for high driving voltage application. In addition to above mentioned advantages, vertical electrode structure can decrease unit area of the chip manufacture. More, it can be beneficial to the conventional wire bonding and package processes of the later process.

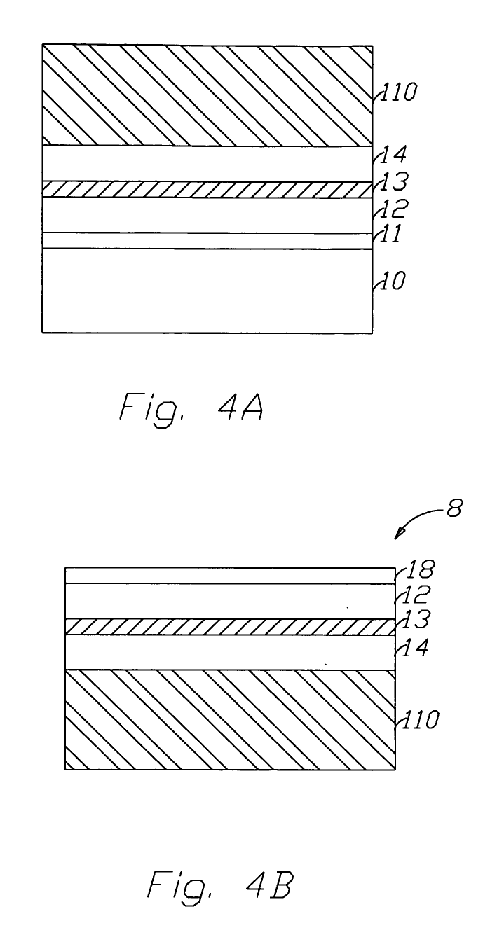

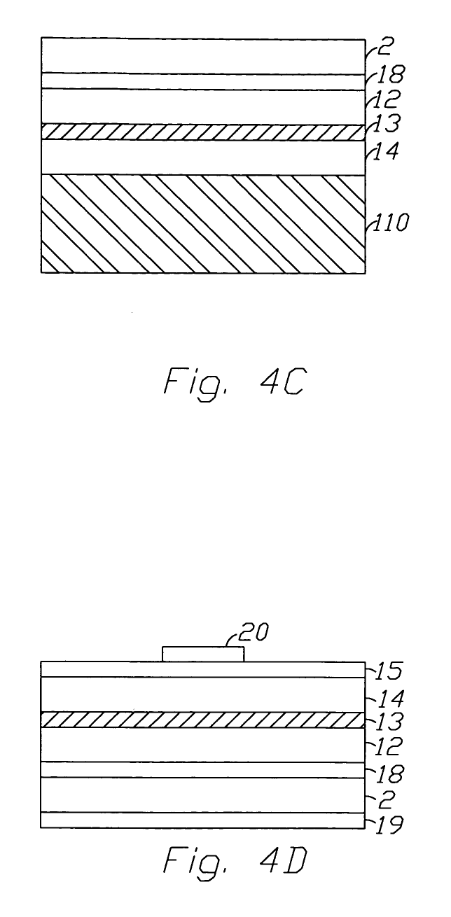

Please referring to FIG. 4A, it is one of the preferred embodiments in the present invention showing a WHITE LEDs structure. As shown in the figure, it is the second preferred embodiment in the present invention showing WHITE LEDs. Firstly, a low temperature GaN buffer layer 11, a N-type AlInGaN ohmic contact layer 12, a AlInGaN light emitting layer 13, and a P-type AlInGaN ohmic contact layer 14 are epitaxially grown on sapphire substrate 10 in order thereto form a GaN LED structure. Next, a temporary substrate 110 uses the thermal bonding method to bond the P-type AlInGaN ohmic layer 14. As shown in FIG. 4B, it later uses a laser lift-off or lapping technique to remove sapphire substrate 10, and shows the N-type AlInGaN ohmic contact layer 12. Next, the evaporation or sputtering techniques individually make the N-type transparently conductive adhesion layer 18 over on the N-type AlInGaN ohmic contact layer 12 as forming a vertical electrode type of GaN LED structure 4, and on a N-type ZnSe or a N-type ZnTe light wavelength transfer substrate 2 as shown in FIG. 3D. Then, it uses wafer bonding method to combine the structure 8 and the structure 6 as shown in FIG. 3C. Next, it removes the temporary substrate 110, and manufactures a transparently conductive ohmic contact layer on the P-type AlInGaN ohmic contact layer 12 as a current spreading layer. Also, the first electrode 20 and the second electrode 19 are manufactured. As shown in FIG. 4D, the N-type transparently conductive adhesion layer 18 can have good ohmic contact with the N-type AlInGaN ohmic contact layer 12, and N-type ZnSe or N-type ZnTe light wavelength transfer substrate as well as with better conductivity and transparency. When the first electrode 20 and the second electrode 19 provide adequate voltage, AlInGaN light emitting layer 13 between the P—N contact layer emits the blue light. Some part of blue light is absorbed by N-type ZnSe or N-type ZnTe light wavelength transfer substrate 2 to form a yellow light. By mixing the blue light and yellow light, it forms a white light. The present preferred embodiment uses high light emitting efficiency GaN LED structure. Besides, an N-type transparently conductive adhesion layer 18 is used to make the light wavelength transfer substrate 2 adhere to the GaN LED structure as manufacturing the vertical structure. The structure makes WHITE LED have better light emitting efficiency. Also, it can increases thermal conductive coefficient of the WHITE LED. As a result, it increases component's operational lifetime, and is more adequately for high driving voltage application. Further, it can increase electrostatic discharge (ESD) stand ability. In addition to above mentioned advantages, vertical electrode structure can decrease unit area of the chip manufacture. More, it can be beneficial to wire bonding and package processes in the conventional use.

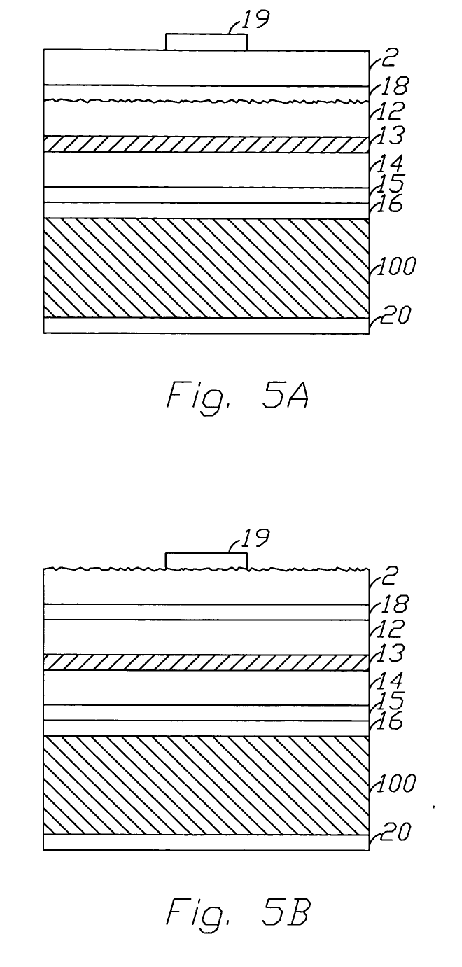

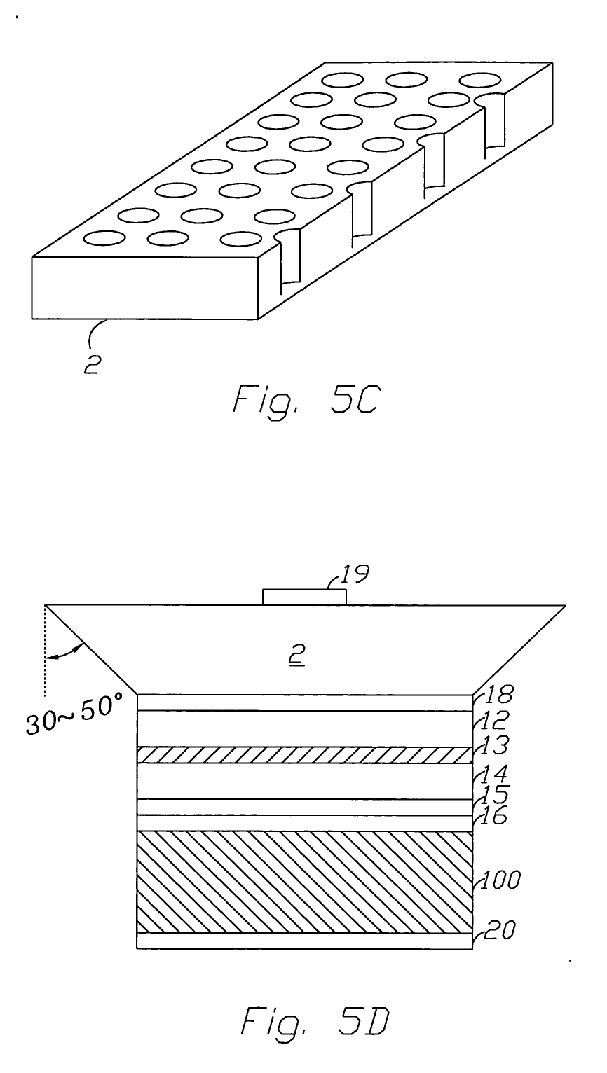

Further, please referring to FIG. 5A, it is another preferred embodiments in the present invention showing WHITE LEDs structure. As shown in the figure, the feature of the first preferred embodiment and the second preferred embodiment in the present invention is the surface of the -type AlInGaN Ohmic contact layer 12 is texturing structure. Therefore, it can further enhance external light emitting efficiency.

Please referring to FIG. 5B, it is another preferred embodiment in the present invention showing WHITE LEDs structure. As shown in the figure, the feature of another embodiment beside to the first embodiment in the present invention is the surface of the light wavelength transfer substrate 2 is a texturing structure or a 2D photonic crystal structure, pleasing referring to FIG. 5C.

FIG. 5D is another preferred embodiment in the present invention showing WHITE LEDs structure. As shown in the figure, the feature of another embodiment beside to the first embodiment in the present invention is the contact area of the light wave length transfer substrate 2 and the transparently conductive adhesion layer is smaller than the one of the light wavelength transfer substrate 2 and the second electrode 20. Also, the contact area of the transparently conductive adhesion layer and the stacking structure of the GaN series semiconductor equals to the contact area of the transparently conductive adhesion layer and the light wavelength transfer substrate. As the result, the light wavelength transfer substrate 2 is not parallel to the surface of the stacking structure in the GaN series semiconductor. The relatively bevel angle in vertical direction is 50˜70 degree.

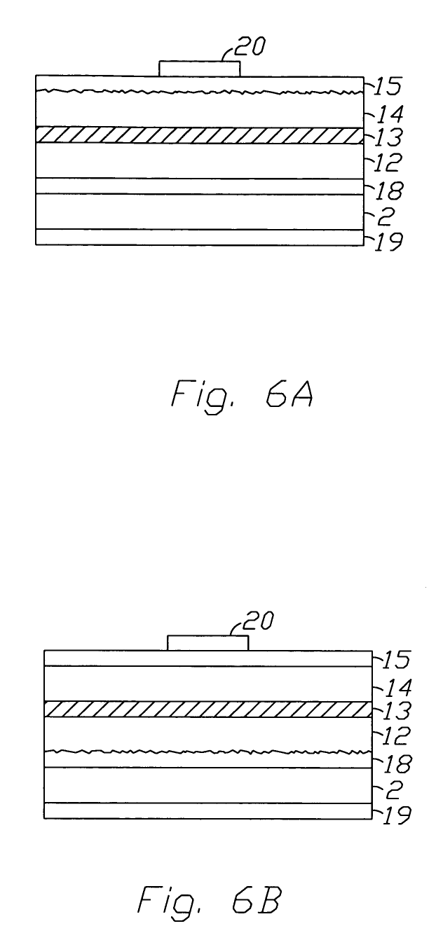

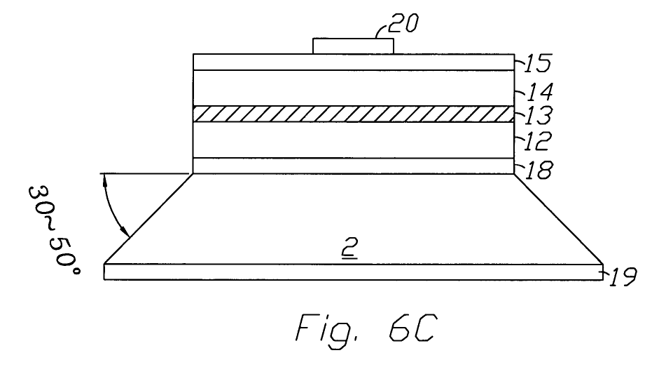

Furthermore, please referring to FIG. 6A, FIG. 6A is one of the preferred embodiments in the present invention showing WHITE LEDs structure. As shown in the figure, the feature of another embodiment beside to the second embodiment of the present invention is the surface of the ohmic contact layer 14 in the P-type GaN series semiconductor is a texturing structure.

FIG. 6B is one of preferred embodiment of the present invention showing WHITE LEDs structure. As shown in the figure, the feature of another embodiment beside to the second embodiment of the present invention is the N-type transparently conductive adhesion layer 18 is a texturing structure.

FIG. 6C is another preferred embodiment in the present invention showing WHITE LEDs structure. As shown in the figure, the feature of another embodiment beside to the second embodiment of the present invention is the contact area of the light wavelength transfer substrate 2 and the transparently conductive adhesion layer is smaller than the one of the light wavelength transfer substrate 2 and the second electrode 20. Also, the contact area of the transparently conductive adhesion layer and the stacking structure of the GaN series semiconductor equals to the contact area of the transparently conductive adhesion layer and the light wavelength transfer substrate. As the result, the light wavelength transfer substrate 2 is not parallel to the surface of the stacking structure in the GaN series semiconductor. The relatively bevel angle in vertical direction is 50˜70 degree.

Up to this point, the embodiments of the present invention have been described with reference to specific embodiments. However, it is not intended to limit the present invention to these specific embodiments. In conclusion, the present invention meets novelty, improvement, and is applicable to the industry. It therefore meets the essential elements in patentability. There is no doubt that the present invention is legal to apply to the patent, and indeed we hope that this application can be granted as a patent.

Additional advantages and modifications will readily occur to those skilled in the art. Therefore, the invention in its broader aspects is not limited to the specific details and representative embodiments shown and described herein. Accordingly, various modifications may be made without departing from the spirit or scope of general inventive concept as defined by the appended claims and their equivalents.

1. A vertical structure of white light emitting diodes comprising:
a first electrode;
a conductive substrate over the first electrode;
a metal adhesion layer over the conductive substrate;
a stacking structure of GaN series semiconductor over the metal adhesion layer;
a transparently conductive adhesion layer over the stacking structure of GaN series semiconductor;
a light wavelength transfer substrate over the transparently conductive adhesion layer; and
a second electrode over the light wavelength transfer substrate.

2. The structure of claim 1, wherein said metal adhesion layer comprises a transparently conductive ohmic contact layer and a metal reflective layer, and the metal reflective layer over the conductive substrate, the light transparently conductive ohmic contact layer over the metal reflective layer.

3. The structure of claim 1, wherein said transparently conductive adhesion layer can be an N-type transparently conductive adhesion layer which can be one chosen from Indium Tin Oxide ITO, Indium molybdenum oxide IMO, Indium Oxide, Tin Oxide, Cadmium Tin Oxide, Gallium Oxide, Indium Zinc Oxide, Gallium Zinc Oxide, or Zinc Oxide.

4. The structure of claim 1, wherein said light wavelength transfer substrate can be one chosen from N-type ZnSe and N-type ZnTe.

5. The structure of claim 1, wherein the surface of the stacking structure in the GaN series semiconductor can be a texturing structure.

6. The structure of claim 1, wherein the stacking structure of the GaN series semiconductor includes a P-type GaN series semiconductor ohmic contact layer, a light emitting layer, and a N-type GaN series semiconductor ohmic contact layer in order.

7. The structure of claim 1, wherein the surface of the ohmic contact layer in the N-type GaN series semiconductor can be a texturing structure.

8. The structure of claim 1, wherein the surface of the wavelength transfer substrate can be a texturing structure.

9. The structure of claim 4, wherein said texturing structure can be a 2D photonic crystal structure.

10. The structure of claim 1, wherein said light wavelength transfer substrate is not parallel to the surface of the stacking structure in the GaN series semiconductor, an the relatively bevel angle in vertical direction is 50˜70 degree.

11. A vertical structure of white light emitting diodes comprising:
a first electrode;
a transparently conductive ohmic contact layer over the first electrode;
a stacking structure of GaN series semiconductor over the transparently conductive ohmic contact layer;
a transparently conductive adhesion layer over the stacking structure of GaN series semiconductor;
a light wavelength transfer substrate over the transparently conductive adhesion layer; and
a second electrode over the light wavelength transfer substrate.

12. The structure of claim 11, wherein the stacking structure of GaN series semiconductor includes a N-type GaN series semiconductor ohmic contact layer, a light emitting layer, and a P-type GaN series semiconductor ohmic contact layer in order.

13. The structure of claim 11, wherein said transparently conductive adhesion layer can be an N-type transparently conductive adhesion layer which can be one chosen from Indium Tin Oxide (ITO), Indium molybdenum oxide (IMO), Indium Oxide, Tin Oxide, Cadmium Tin Oxide (CTO), Gallium Oxide, Indium Zinc Oxide (IZO), Gallium Zinc Oxide (GZO), or Zinc Oxide (ZnO).

14. The structure of claim 11, wherein said light wavelength transfer substrate can be one chosen from N-type ZnSe and N-type ZnTe.

15. The structure of claim 11, wherein the surface of the stacking structure in the GaN series semiconductor can be a texturing structure.

16. The structure of claim 11, wherein the surface of the ohmic contact layer in the P-type GaN series semiconductor can be a texturing structure.

17. The structure of claim 11, wherein the surface of the transparently conductive adhesion layer can be a texturing structure.

18. The structure of claim 11, wherein said light wavelength transfer substrate is not parallel to the surface of the stacking structure in the GaN series semiconductor. The relatively bevel angle in vertical direction is 50˜70 degree.
